(19) United States
(12) Patent Application Publication
(10) Pub. No.: US 2024/0338611 A1
(43) Pub. Date: Oct. 10, 2024

(54) MODEL SELECTION IN ENSEMBLE LEARNING

(71) Applicant: Intuit, Inc., Mountain View, CA (US)

(72) Inventors: Eyal SHAFRAN, Salt Lake City, UT (US); Bor-Chau JUANG, Santa Clara, CA (US); Steven J. BROWN, Champlin, MN (US); Linxia LIAO, Palo Alto, CA (US); Nicholas R. JOHNSON, Tucson, AR (US); Christiana Mei Hui CHEN, San Francisco, CA (US)

(21) Appl. No.: 18/131,831

(22) Filed: Apr. 6, 2023

(51) Int. Cl. G06N 20/20

(52) U.S. Cl. CPC G06N 20/20; G06N 3/0985; G06N 5/04

(57) ABSTRACT

Certain aspects of the present disclosure provide techniques for detecting data errors. A method generally includes training each of a plurality of models on a plurality of training data sets to generate a set of trained models, determining a plurality of subsets of trained models from the set of trained models, for each respective subset: determining a plurality of ensemble outputs for the respective subset based on a plurality of validation data sets; and determining at least one evaluation metric for the respective subset based on the plurality of ensemble outputs; and determining an ensemble model as a subset of trained models having a best evaluation metric among a plurality of evaluation metrics associated with the plurality of subsets, wherein each subset comprises a different selection of models from the set of trained model than each other subset of trained models in the plurality of subsets of trained models.

### INTRODUCTION

Aspects of the present disclosure relate to ensemble learning, and more specifically, to selecting constituent models for an ensemble model.

### BACKGROUND

The development of ensemble methods has gained significant attention over the past years, particularly in areas of machine learning and data mining. Application of ensemble methods in machine learning (referred to herein as “ensemble learning”) provides a technique that combines several base machine learning models (referred to the in the art as “base learners”) in order to produce an improved predictive model. In other words, ensemble learning uses multiple machine learning models to obtain better predictive performance than could be obtained for any of the constituent machine learning models alone.

The improved predictive model produced as a result of combining multiple machine learning models, has been theoretically and experimentally shown to reduce variance and bias compared to the use of only a single model. In machine learning models, bias and variance are major sources of error. Bias is the difference between actual and predicted values. Bias refers to the simple assumptions that a model makes about data to be able to predict new data. A model with high bias makes more assumptions and, in some cases, oversimplifies the model. On the other hand, variance refers to variability in model prediction—how much a machine learning algorithm adjusts depending on a given data set. A model with high variance may represent a dataset accurately but may lead to overfitting to noisy or otherwise unrepresentative training data. The ensemble methods in machine learning help to minimize one or more of these error-causing factors, wherein the error(s) minimized are based on a technique selected for combining the base machine learning models. For example, in ensemble learning, multiple machine learning algorithms are trained on a same dataset to build trained models. Each of the trained models is then used to generate an output prediction for identical input data. The generated output predictions are combined, in various ways, to produce a single output prediction for the input data. Conventional approaches for combining the output predictions of each of the trained models to produce an optimal output prediction include weighted averaging and stacking. Weighted averaging techniques involve combining the output predictions from the multiple trained models, where the contribution of each model to the final output prediction is weighted, in some cases, proportionally to each model's capability or skill. Lastly, stacking refers to a technique which uses an additional machine learning model to learn how to best combine the output predictions from contributing ensemble members (e.g., the trained models) to generate the final output prediction. The different techniques used in ensemble learning may have a positive impact on reducing bias, reducing variance, and/or improving predictive performance.

Selection of the constituent models for an ensemble model has a direct impact on predictive performance of the ensemble; however, the selection of the best ensemble model presents a difficult technical problem. Model selection is often manually performed by a human and requires advanced knowledge about any candidate models from which the ensemble model is selected. Specifically, a selector (e.g., a human) of models for the ensemble may need to have knowledge about parameters, as well as performance of each of the different models in the pool (e.g., for different datasets), among other factors, to make an informed selection. Further, the selector may need to have at least generalized knowledge about advantages and/or disadvantages of each model type in the pool of models, but a selector of the models may not always possess such knowledge, or it may be impractical to obtain such knowledge.

Moreover, selection of the best ensemble model from a set of candidate models may be classified as a non-deterministic polynomial-time (NP) hard (NP-hard) combinatorial search problem. NP-hard problems are difficult to solve because they involve a large number of potential solutions that must be checked in order to find the best solution. This is generally an extraordinarily time-consuming process when there are many options from which to choose a solution. The time for determining a best ensemble model from a candidate set of models increases exponentially with the number of candidate models to select from. Thus, selection of the best ensemble model is not only generally impractical to perform by humans (e.g., as a mental process), but is often impractical to perform even with high-powered computing equipment.

Thus a technical problem exists in the art regarding the selection of a set of models for an ensemble model. Because there is a need for improved machine learning model performance, and ensemble models may provide such an improvement, there is a need for improved techniques for selecting an ensemble model from a set of candidate models.

### SUMMARY

Certain embodiments provide a method for selecting an ensemble model. The method generally includes training each of a plurality of models on a plurality of training data sets to generate a set of trained models. The method generally includes determining a plurality of subsets of trained models from the set of trained models. Each subset of trained models comprises a different selection of models from the set of trained model than each other subset of trained models in the plurality of subsets of trained models. For each respective subset of trained models of the plurality of subsets of trained models, the method generally includes determining a plurality of ensemble outputs for the respective subset of trained models based on a plurality of validation data sets and determining at least one evaluation metric for the respective subset of trained models based on the plurality of ensemble outputs. The method generally includes determining an ensemble model as a subset of trained models from the plurality of subsets of trained models having a best evaluation metric among a plurality of evaluation metrics associated with the plurality of subsets of trained models.

Certain embodiments provide a method for selecting an ensemble model. The method generally includes determining a plurality of subsets of trained models from a set of trained models. The set of trained models comprises a plurality of models trained on a plurality of training datasets. Each subset of trained models comprises a different selection of models from the set of trained model than each other subset of trained models in the plurality of subsets of trained models. For each respective subset of trained models of the plurality of subsets of trained models, the method generally includes determining a plurality of ensemble outputs for the respective subset of trained models based on a plurality of validation data sets and determining at least one evaluation metric for the respective subset of trained models based on the plurality of ensemble outputs. The method generally includes determining an ensemble model as a subset of trained models from the plurality of subsets of trained models having a best evaluation metric among a plurality of evaluation metrics associated with the plurality of subsets of trained models

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 illustrates an example system for selecting an ensemble model from a set of candidate models.

FIGS. 2A-2C illustrate an example method for selecting an ensemble model from a set of candidate models.

FIG. 3 illustrates example model groupings for selecting an ensemble model from a set of candidate models.

FIG. 4 illustrates example predictive performance results for an ensemble model selected using the example method described in FIG. 2.

FIG. 5 illustrates an example processing system on which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Determining the best ensemble model from a set of candidate models is a technically challenging problem along many dimensions. Initially, assembling a candidate set of models is difficult because many types of models exist and determining the right types and configurations of models for a given task and dataset is a challenging search problem that has proved resistant to automation. Further yet, to have a large pool of candidate models to choose from for an ensemble, a large pool of candidate models must be designed, trained, and tested, which is extraordinarily resource intensive. These and other reasons are why selecting the best ensemble out of a pool of candidate models is an NP-hard combinatorial search problem that is impractical for a human to perform and often impractical for even high-powered computing equipment to perform. And while achieving the best ensemble may naturally suggest having the largest pool of candidate models to choose from, the complexity of the combinatorial search problem grows exponentially with the number of candidate models in the pool.

Conventional approaches to ensemble selection have thus been more empirical in nature. For example, a conventional approach is to rely on human's knowledge to select an ensemble model from a pool of candidate models. However, a human's personal opinions, feelings, and/or experience with particular models, and their performance, may influence their ensemble selection in sub-optimal ways. Further, as this is an inherently subjective method, it is not repeatable or scalable. Accordingly, conventional manual methods for selecting an ensemble model are not effective.

Embodiments described herein overcome the aforementioned technical problems and improve upon the state of the art by providing an approach for ensemble model selection that iteratively searches over subsets of models from a pool of candidate models to create an ensemble model that improves task performance, where the task may be a classification task, a regressive task, a forecasting task, and others. The pool of candidate models may include a plurality of models trained on one or more related training datasets. In some embodiments described herein, multiple expanding windows of training data may be used to train the candidate models in the pool. Each subset of models generally comprises two or more of the candidate models from the pool, and each subset generally includes a different selection of models than any other subset of models. Performance of each subset of models is evaluated using, for example, cross validation techniques (e.g. techniques that use a validation dataset to test the performance of a model, where the validation dataset corresponds to a training dataset used to train the model). A subset of models is ultimately selected as the ensemble model based on having the best performance of the subsets considered.

In embodiments described herein, the output of the model subsets that are evaluated and the output of the ultimately selected ensemble may be based on a median value of the outputs of all models in any subset or ensemble. Using the median output of an ensembled set of models improves the ensembled model performance as compared to other approaches, like weighted averaging and/or stacking techniques-especially in cases where performance of at least one of the models in the ensemble is poor. Unlike the weighted averaging and stacking techniques, the median approach tends to handle outlier outputs of models in the ensemble better without affecting overall ensemble model performance.

For example, a selected ensemble model may include three machine learning models, including a linear regression model, a random forest model, and a gradient boosted model. Each model is used to generate an output prediction for identical input data. The linear regression model may perform poorly and produce an outlier output when compared to the outputs of the random forest and gradient boosting models. With weighted averaging and/or stacking techniques, this outlier output would skew the final ensemble model output. However, when using a median output of the ensemble, the linear regression model output will, at most, affect the ordering of the outputs for median selection, but will not affect the ultimate output of the ensemble. As such, median output selection from the selected ensemble may provide better predictive performance than weighted averaging and/or stacking techniques.

Although underperformance by a model in an ensemble is mitigated by using a median output technique, the impact of the poorly performing model may nevertheless be material. In fact, task performance when using a median output from an ensemble of models may be limited based on the underlying ensemble model used. For example, a ratio of poor performing models to the total number of models in the ensemble, a maximum number of models in the ensemble, a minimum number of models in the ensemble, diversity among the models in the ensemble, and/or the like, are factors that may cause the task performance to fluctuate when using a median output from an ensemble model. Accordingly, embodiments described herein select the ensemble model in such a way to ensure that the underlying models in the selected ensemble improve overall task performance when using a median output.

Various techniques are described herein for further improving ensemble selection. In particular, subsets of models may be required to have a minimum number of models and/or a maximum number of models in some embodiments. Further, in some embodiments, models may be grouped based on characteristic(s) common to each model group, and subsets may be limited to having only one model from each model group. Thus, embodiments described herein may bound the model subset size and composition in ways that beneficially reduce computational complexity and resources requirements when evaluating model subsets to select an ensemble model as compared to exhaustive search methods.

As such, the ensemble model selection approach described herein provides significant technical advantages over conventional approaches, including improving the efficiency of selecting the ensemble as well as the task performance of the selected ensemble.

### Example System for Ensemble Model Selection

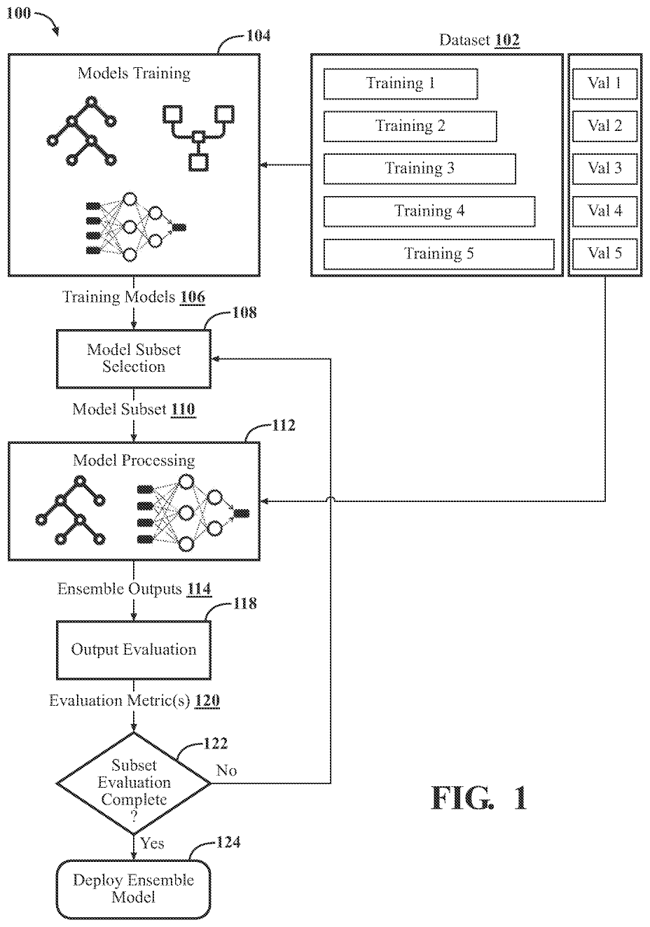

FIG. 1 illustrates an example system 100 for selecting an ensemble model. As illustrated, system 100 is configured to iteratively evaluate model subsets 110 to determine a high performance ensemble model for a given task. The selected ensemble model includes a subset of models that provides improved task performance as compared to other model subsets 110 evaluated by system 100.

To select an ensemble model, system 100 begins by training, at 104 in FIG. 1, multiple candidate models using a dataset 102. Dataset 102 includes example data (e.g., data inputs and their corresponding target output(s) (or label(s))) used to train a machine learning model. In this example, dataset 102 is partitioned into multiple training and validation datasets. The trained models 106 form a pool (or set) of trained models 106 from which different model subsets 110 may be selected for evaluation.

In certain embodiments, training datasets are formed using one or more expanding windows (e.g., expanding time windows). Using this approach effectively creates different training datasets from a single overarching dataset. In the depicted example, the validation data windows are the same size.

Although FIG. 1 illustrates system 100 training multiple models 106 to create the different model subsets 110 (e.g., having two or more of the trained models 106), in certain embodiments, system 100 forms the different model subsets 100 from a pool of pre-trained models, such that system 100 is not performing the training at 104. Instead, system 100 may have access to the pool of pre-trained models (e.g., publically available models) and may form model subsets 110 from this pool of pre-trained models. In other words, the pool of pre-trained models may be available independent of any model training performed by system 100. In some cases, a pool of pre-trained models may be augmented by additional trained models (such as performed at 104).

At 108, system 100 forms different model subsets 110 from the pool of trained models 106. Each model subset 110 includes two or more trained models 106 selected from the pool of trained models 106. In certain embodiments, trained models 106 are selected for each model subset 110 based on one or more selection rules, as described further below.

For a selected model subset 110, system 100 processes at 112 each model in the selected model subset 110 with each validation dataset of dataset 102 (e.g., VAL 1 through VAL 5 in the depicted example) and thereby generates an output for each model and each validation dataset. As such, a number of outputs generated by the selected model subset 110 during model processing 112 is the number of models in the model subset, M, times the number of validation datasets used, N, or M×N.

As an illustrative example, dataset 102 may include five validation datasets (e.g., N=5) and a selected model subset 110 may include three trained models 106 (e.g., M=3). Using each of the three trained models 106 in the selected model subset to process each of the five validation datasets results in fifteen model subset outputs 114 (e.g., M×N=5×3=15 outputs). The median output prediction for each validation dataset may represent is then used as ensemble output 114 for the validation dataset. Thus, in this example, five ensemble outputs 114 are generated.

At 118, system 100 evaluates the performance of a selected model subset 110 based on the ensemble outputs 114 generated by the selected model subset 110 to generate an evaluation metric 120 for the selected model subset 110. In one example, the evaluation metric is a weighted mean absolute percentage error (wMAPE), however, many other evaluation metrics are possible, including a root square mean error (RSME) or a mean absolute error (MAE).

System 100 thus evaluates the performance of all model subsets 110 and generates evaluation metrics for each, which allows for objectively comparing the performance of each model subset. When all model subsets 110 have been evaluated, e.g., determined at 122, system 100 determines the best model subset 110 based on the best evaluation metric and deploys the selected model subset 110 as an ensemble model at 124. Deployment of the ensemble model at 124 may involve processing input data using each of the ensemble model to perform a useful task, such as forecasting. Further, in some cases deploying the ensemble model may include loading or installing the ensemble model onto a separate device so that the separate device can process data with the ensemble model.

The ensemble model selection approach described with reference to FIG. 1 (and further herein) provides significant technical effects and advantages over conventional approaches, including a significant reduction in time and resources (e.g., compute, memory, and energy) used to select an ensemble model while also improving the task performance of the selected ensemble model. Further, the methods described herein improves the likelihood and thus confidence that the selected ensemble is the best ensemble (e.g., in terms of task performance measured by the evaluation metric) of the pool of trained models. Accordingly, the methods described with respect to FIG. 1 (and further herein) overcome technical problems associated with conventional ensemble selection methods.

Notably, system 100 may be used by any user irrespective of their level of knowledge of different machine learning models. In particular, the system is designed to select an ensemble model without user input.

Notably, the improved ensemble determined by way of system 100 may improve the function of any existing application that uses machine learning model(s) for useful task. For example, an application using a single model may be replace that model with an ensemble model selected by system 100, and the ensemble mode may generally have improved bias, variance, and task performance compared to the replaced model.

### Example Method for Selecting an Ensemble Model

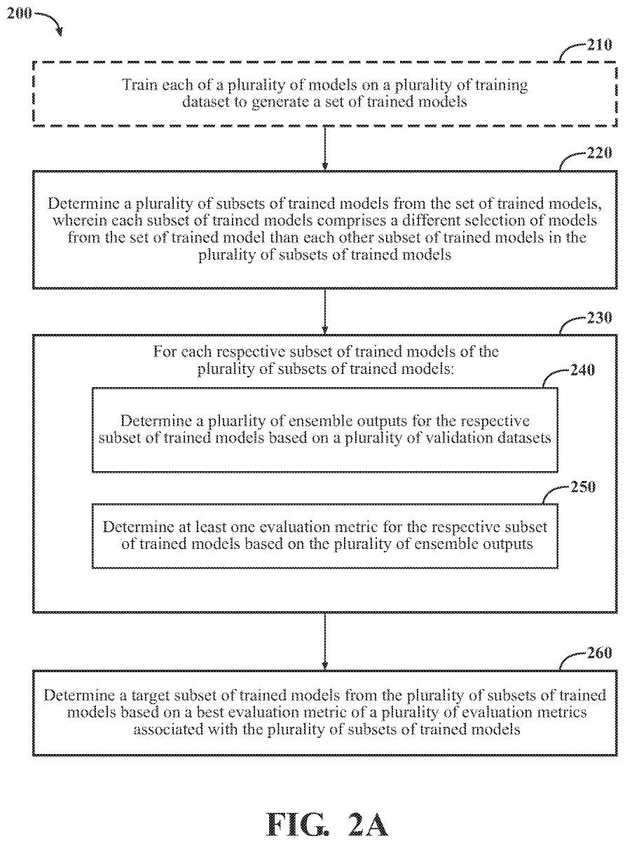

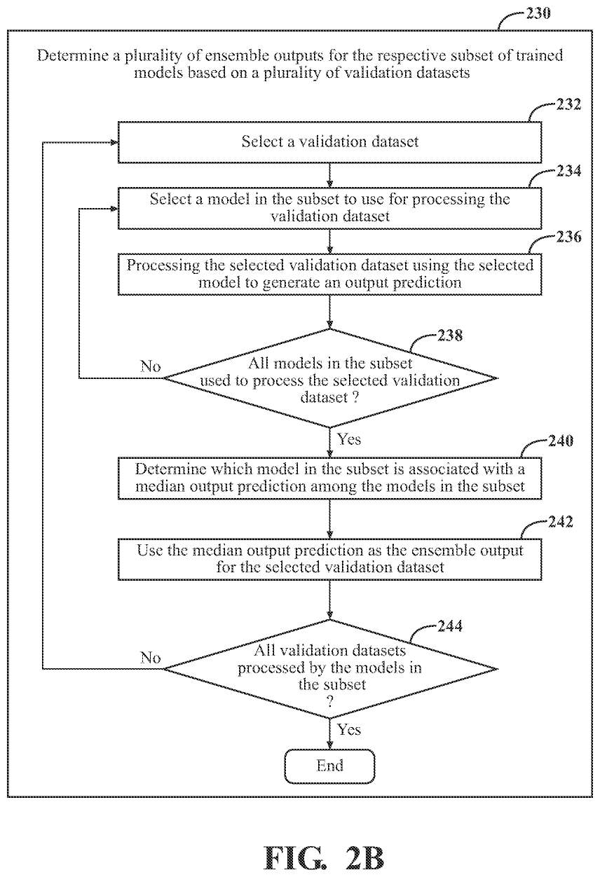

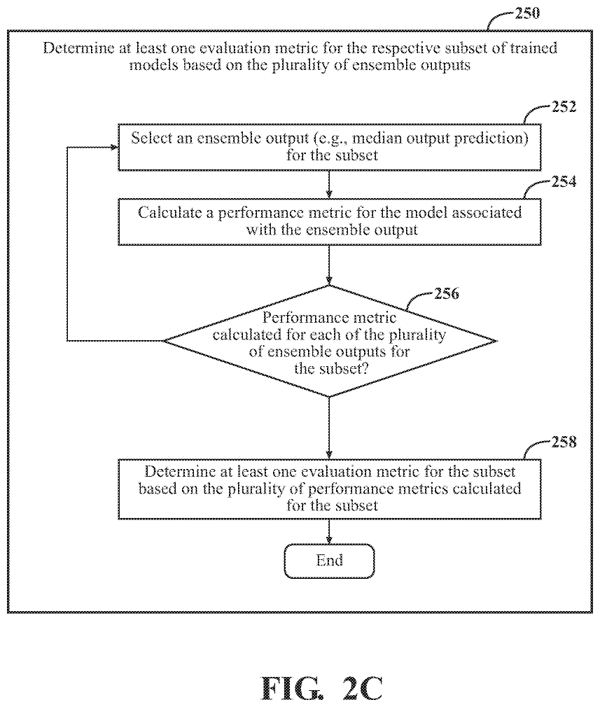

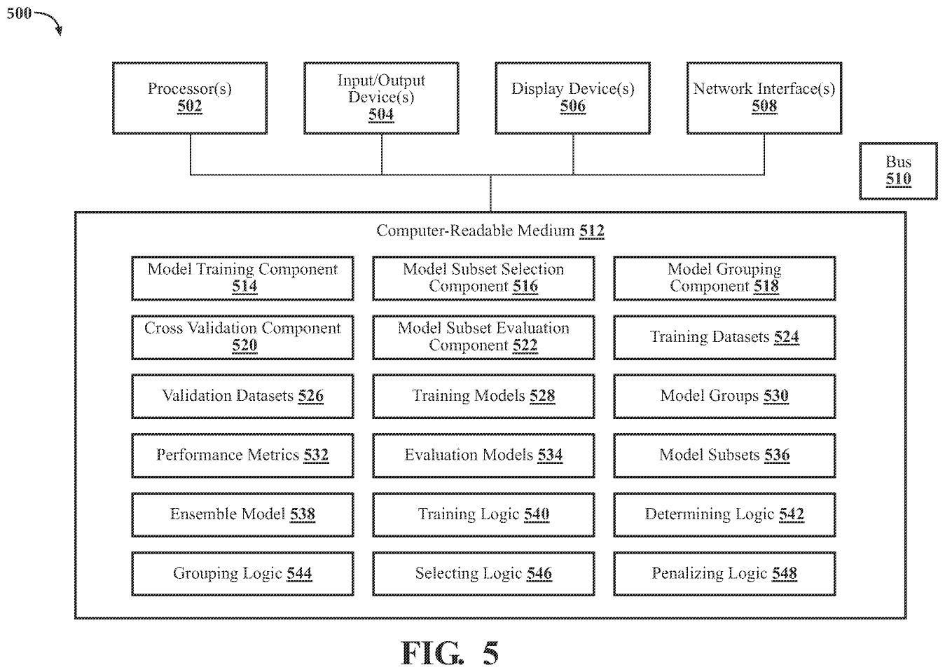

FIGS. 2A-2C illustrate an example method 200 for selecting an ensemble model. Method 200 may be performed by one or more processor(s) of a computing device, such as processor(s) 502 of processing system 500 described below with respect FIG. 5. As described above, selecting an ensemble model (e.g., an ensemble model from a set of models) involves forming subsets of trained models from a pool (or set) of trained models, evaluating each of the subsets' performance (e.g., by way of an evaluation metric) using a median output approach, and determining the subset of trained models having the best performance to deploy as an ensemble model.

Method 200 begins, at step 210 by training each of a plurality of models on a plurality of training datasets (e.g., N training datasets from dataset 102 in FIG. 1) to generate a set of trained models (e.g., X trained models 106 in FIG. 1, where X is any positive integer). Training each individual model may be performed based on a machine learning algorithm associated with the model type, such as deep learning for a neural network model, binary recursive partitioning for tree-based models, and others.

As described above, in certain embodiments, instead of training a plurality of models on a plurality of training datasets at step 210, pre-trained models may be obtained. As such, method 200 may not require the system to initially train the models.

Method 200 proceeds to step 220 with determining a plurality of subsets of trained models (e.g., model subsets 110 in FIG. 1) from the set of trained models. Each subset of trained models includes a different selection of models from the set of trained models than each other subset of trained models in the plurality of subsets of trained models.

As mentioned above, an exhaustive search of model subsets is computationally intensive. For example, given a set of ten trained models, (2ⁿ−1)=(2¹⁰−1)−(1,024−1)=1,023 subsets of trained models may be formed. Each of these 1,023 subsets would then be evaluated to determine a subset to be deployed as an ensemble model. Accordingly, embodiments described herein limit the number of subsets that are considered without limiting the expectation of finding a high performance model.

In certain embodiments, the determined subsets of trained models are bounded by a minimum number of trained models and/or a maximum number of trained models. For example, where Z represents a number of trained models in a subset, a maximum number of trained models per subset is equal to five, and a minimum number of trained models per subset is equal to three, Z may be limited to 3≤Z≤5. Now assuming that the total number of trained models is again 10, then the limitations on the subset size reduces the search space from 1,023 subsets to

$$\frac{10 !}{3 ! ( 10 - 3 ) !} + \frac{10 !}{4 ! ( 10 - 4 ) !} + \frac{10 !}{5 ! ( 10 - 5 ) !} = 120 + 210 + 252 = 582 ,$$

which is about half the amount of subsets to search.

In certain embodiments, the set of trained models are grouped into a plurality of model groups based on at least one characteristic common to each model group. In this case, the generated subsets may be limited to having only one model from each model group. In other words, no more than one model from each model group of the plurality of model groups may be selected to form each subset (e.g., thereby also reducing the original 1,023 possible subsets where the determined subsets were not limited). Model grouping prior to subset selection has multiple beneficial technical effects. First, grouping reduces the total number of subsets that need evaluation, thereby saving computational resources and time. Further, limiting the number of models selected from any given model group for a particular model subset, helps to create diversity among models in each subset (e.g., insuring that all the models in a particular subset are not the same type). Because different types of models are likely to make different types of errors, improving model diversity within a subset (or ensemble) may beneficially reduce overall error of the model subset and thereby improve model subset task performance.

Further, in certain embodiments, to further reduce the subset search space, one or more models within each model group are penalized based on one or more factors, such that each of the model groups includes (1) penalized model(s) and (2) non-penalized model(s). For example, a more complex model that performs the same as a less complex model may be penalized because, in general, it may be advantageous to use the a less complex model because such a model would require less computational resources (e.g., memory and compute cycles). As such, in some embodiments, when determining the subsets at step 220, only non-penalized models from each model group are selected (e.g., penalized models may not be included in any model subset).

Another factor that may be used for penalizing models within a group is model training time. Thus, models in each model group that took a longer amount of time to train (e.g., using the training datasets) than other models in the model group and/or took an amount of time to train greater than a maximum time threshold are penalized. Penalizing models with longer training times restricts adding such models to the different model subsets that are formed (e.g., from at least one model per model group). Limiting the model subsets to models with shorter training times (e.g., by penalizing models with longer training times) may help to reduce computational time and/or resources needed when one of these subsets is determined to be the selected ensemble model.

Another factor that may be used for penalizing models within a group is an amount of model parameters. Thus, models in each group that have a greater amount of parameters than other models in the model group and/or have an amount of parameters greater than a maximum parameter threshold are penalized. Penalizing models with a larger number of parameters restricts adding such models to the different model subsets that are formed (e.g., from at least one model per model group). Limiting the model subsets to model with less parameters (e.g., by penalizing models with large amounts of parameters) may also help to reduce computational time and/or resources needed when one of these subsets is determined to be the selected ensemble model.

As used herein, a model parameter is generally a trainable (e.g., changeable) aspect of a model. Example model parameters may include weights and biases.

Another factor that may be used for penalizing models within a group is similarity (e.g., based on model parameters) between models within a group. For example, two or more models in a group may have similar model parameters, thereby causing performance of these models to also be similar when performing a task. To reduce duplicative efforts of evaluating subsets which include similar models (e.g., to avoid evaluating a first subset which includes a first model from a first group and a second model from a second group and subsequently evaluating a second subset which includes the same first model from the first group and a second model from the second group where the second model from the second group is similar (e.g., has similar parameters) to the first model from the second group), embodiments described herein may penalizing at least one of the similar models. For example, where two models in a group have similar parameters, one of the similar models may be penalized while the other model is not penalized. This choice may be random between similar models, or the choice may be based on model performance, or other metric. Penalizing similar models helps to avoid wasting computational resources needed to evaluate different subsets for purposes of determining a target model subset that provides improved predictive performance in ensemble learning, over other model subsets.

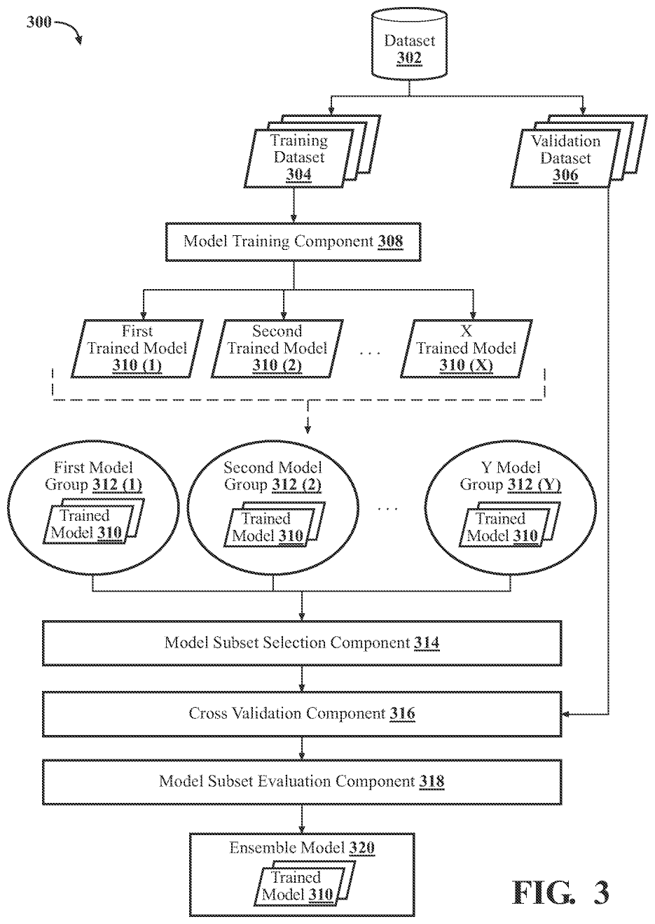

Notably, the various methods for reducing the total number of model subsets evaluated may be used in combination. For example, a minimum and maximum subset size (in terms of number of models in the subset) may be used in conjunction with grouping. Additional details regarding grouping the models into model groups, penalizing models of each model group, and selecting models from model groups to form models subsets are provided below with respect to FIG. 3.

Method 200 then proceeds to step 230 with determining, for each respective subset of trained models of the plurality of subsets of trained models, a plurality of ensemble outputs (e.g., ensemble outputs 114 in FIG. 1) for the respective subset of trained models based on a plurality of validation datasets (e.g., validation datasets from dataset 102 in FIG. 1). Determining the plurality of ensemble outputs for each subset of trained models is described in more detail in FIG. 2B.

As illustrated in FIG. 2B, step 230 includes steps 232-244 in one embodiment. In such embodiments, steps 232-244 are performed for each subset of trained models determined at step 220. Steps 232-244 are described below with respect to a single subset of trained models of the plurality of subsets of trained models; however, similar steps may be performed for each of the different subsets in the plurality of subsets.

At step 232, a validation dataset among the plurality of datasets is selected (e.g., one of VAL 1 through VAL 5 in FIG. 1). In certain embodiments, the first validation dataset is selected at random.

At step 234, a model in the subset is selected. The selected model may be used for processing the validation dataset selected at step 232.

At step 236, the selected validation data is processed using the selected model to generate an output prediction. In certain embodiments, the generated output prediction is a forecast value.

At step 238, a determination is made regarding whether all models in the subset have been used to process the validation dataset, selected at step 232. If not all models belonging to the subset have been used to process the selected validation dataset (e.g., the subset includes three models and only one of the models has been used to process the validation dataset), then method 200 returns to step 234 to select another model and repeat steps 234-238.

On the other hand, if all models belonging to the subset have been used to process the selected validation dataset (e.g., the subset includes three models and three models have been used to process the validation dataset), then method 200 proceeds to step 240.

At step 240, a median output prediction among the output predictions generated by the models in the subset, for the selected validation dataset, is determined. Further, the model in the subset associated with this median output prediction (e.g., the model which generated this output prediction) is identified. For example, where the subset includes three models, three output predictions may have been generated at step 236. A median output prediction among these three output predictions is determined, and further a model associated with this median output prediction is identified.

At step 242, the median output prediction (e.g., determined at step 240) is used as the ensemble output (e.g., ensemble output 114 in FIG. 1) for the selected validation dataset.

At step 244, a determination is made whether all validation datasets have been processed by all models in the subset. If not all validation datasets have been processed (e.g., three validation datasets exist and only one has been processed by each model in the subset to generate output predictions, and further generate an ensemble output), then method 200 returns to step 232 to select another validation dataset and repeat steps 232-244.

On the other hand, if all validation datasets have been processed by models in the subset (e.g., three validation datasets exist and all three validation datasets have been processed by each model in the subset to generate output predictions, and further generate three ensemble outputs), then step 230 is complete.

Subsequent to step 230, method 200 proceeds to step 250 with determining, for each respective subset of trained models of the plurality of subsets of trained models, at least one evaluation metric (e.g., evaluation metric(s) 120 in FIG. 1) for the respective subset of trained models based on the plurality of ensemble outputs. Determining at least one evaluation metric for each subset of trained models is described in more detail in FIG. 2C.

As illustrated in FIG. 2C, step 250 includes steps 252-258 in one embodiment. Steps 252-258 are performed for each subset of trained models, determined at step 220. Steps 252-258 are described below with respect to a single subset of trained models of the plurality of subsets of trained models; however, similar steps may be performed for each of the different subsets in the plurality of subsets.

At step 252, an ensemble output (e.g., median output prediction for a validation dataset) for the subset is selected (e.g., ensemble output 114 in FIG. 1). In certain embodiments, the first ensemble output is selected at random. For example, at 230, three ensemble outputs may have been generated for a subset of models where three validation datasets exist (e.g., one ensemble output determined per validation dataset). Thus, at 252, one of these ensemble outputs may be selected for further evaluation.

At step 254, a performance metric for the model associated with the ensemble output (e.g., the model that produced the median output prediction for the validation dataset) is calculated. In certain embodiments, the calculated performance metric is a weighted mean absolute percentage error (wMAPE). The wMAPE is calculated using the final prediction of the model that produce the median output prediction and the true expected value.

At step 256, a determination is made whether a performance metric has been calculated for each of the plurality of ensemble outputs determined for the subset. If a performance metric has not been calculated for each of the plurality of ensemble outputs determined for the subset, then method 200 returns to step 252 to select another ensemble output (e.g., determined for the subset at steps 240 and 242 in FIG. 2B) and repeat steps 252-256.

On the other hand, if a performance metric has been calculated for each of the plurality of ensemble outputs determined for the subset, then method 200 proceeds to step 258.

At step 258, at least one evaluation metric (e.g., evaluation metric(s) 120 in FIG. 1) is determined for the subset based on the plurality of performance metrics calculated for the subset. In certain embodiments, the evaluation metric determined for the subset is calculated as an average of the performance metrics calculated for the subset (e.g., where the performance metrics are wMAPEs, the calculated evaluation metric is an average wMAPE). In certain embodiments, the evaluation metric determined for the subset is calculated as a standard deviation of the performance metrics calculated for the subset (e.g., where the performance metrics are wMAPEs, the calculated evaluation metric is a standard deviation calculated for the wMAPEs). In certain embodiments, the evaluation metrics determined for the subset include both and average and a standard deviation. Step 250 is complete after step 258.

Returning to FIG. 2A, subsequent to step 250, method 200 proceeds to step 260 with determining a model subset from the plurality of model subsets having a best evaluation metric of a plurality of evaluation metrics associated with the plurality of model subsets. In certain embodiments, the selected model subset may be the model subset having a lowest average wMAPE.

The target subset, selected at step 250, may be deployed for use in ensemble learning to make predictions and/or to perform a desired task. In some cases, the ensemble learning is performed using a median output selection technique.

### Example Grouping of Models for Selecting Model Subsets

FIG. 3 illustrates example grouping models 300 for selecting model subsets.

As described above, in certain embodiments trained models are selected for each model subset based on one or more selection rules. For example, in certain embodiments, trained models in a pool of trained models may be grouped based on characteristic(s) common to each model group, and model subsets may be limited to having only one trained model from each model group. Limiting the number of models per model group in each model subset (e.g., limiting to one model per model group) helps to reduce the total number of model subsets that need to be evaluated (e.g., given a pool of trained models), thereby reducing computational complexity and resources requirements when determining ensembles. Further, limiting the number of models per model group in each subset, to one model per group, helps to create diversity among models in each subset. Model diversity may improve the performance of the subset in performing a task, as it helps to ensure that the individual models, included in each subset, are different from each other and do not reinforce inherent weaknesses of model types.

Similar to FIG. 1, in FIG. 3, a dataset 302 includes a plurality of training datasets 304 and a plurality of corresponding validation datasets 306. A plurality of models may be trained on the training datasets 304. The trained models may include models 310 (1)-310 (X) (collectively referred to herein as models 310).

As illustrated in FIG. 3 trained models 310 are grouped into models groups 312 (1)-312 (Y) (collectively referred to herein as model groups 312), where Y is any positive integer. Trained models 310 are grouped into model groups 312 based on at least one characteristic common to each model group 312.

In certain embodiments, trained models 310 are grouped into different model groups 312 based on model type (e.g., the common characteristic). For example, four model groups 312 may be created having one or more trained models 310, where each model group 312 corresponds to one of the following model types: supervised models, semi-supervised models, unsupervised models, and reinforcement models. Other model types may be considered for grouping in other embodiments. As another example, the model types may include: neural networks, tree-based models, support vector machines, and logistic regressions.

In certain embodiments, trained models 310 are grouped into different model groups 312 based on model output or types of tasks. For example, the types of output may include regression, classification, and clustering. Organizing trained models 310 into model groups 312 based on model output helps to combine similar models in same model groups 310.

In certain embodiments, trained models are grouped into different model groups 312 based on both model type and model output, and/or other characteristics. In fact, the characteristics identified herein are not exhaustive, and other characteristics may be used to group trained models 310 into different model groups 312.

After generating model groups 312, a model subset selection component 314 is used to select model subsets, similar to 108 in FIG. 1. However, in FIG. 3, model subsets are generated such that no more than one trained model 310 from each model group 312 is selected for each model subset. For example, three model groups may exist. A first model group 312 (1) includes three trained models 310, a second model group 312 (2) includes three trained models 310, and a third model group 312 (3) includes one trained model 310. A first model subset may include three trained models 310, where each trained model 310 belongs to one of the model groups 312. A second model subset may include two trained models 310, where one of the trained models 310 in the second model subset belongs to first model group 312 (1) and the other trained model 310 in the second model subset belong to second model group 312 (2). Similarly, other model subsets may be created for the three model groups.

In other embodiments, the number of models selectable from any given group may be more than one, but subject to an upper limit, such as no more than two, or three, etc.

As described above, in certain embodiments, trained model(s) 310 from each model group 312 are penalized based on one or more factors (e.g., model training time, an amount of model parameters, model parameter types, and/or the like), such that each of the model groups includes (1) penalized trained model(s) 310 and (2) non-penalized model(s) 312. As such, when subset selection component 314 selects the different model subsets, only non-penalized trained models 310 from each model group 312 may be selected for the model subsets (e.g., penalized trained models 310 may not be included in the model subsets). Alternatively, non-penalized models may be preferentially selected, but penalized models may be selected when necessary to meet a minimum number of models in any given subset.

After creation of the model subsets, cross validation component 316 and model evaluation component 318 may perform similar operations described above with respect to 112, 118, and 122 in FIG. 1, to evaluate a performance of each model subset, to determine an ensemble model 320. The ensemble model 320 may be a model subset from the plurality of model subsets having a best evaluation metric.

### Example Results Using the Method for Selecting an Ensemble Model

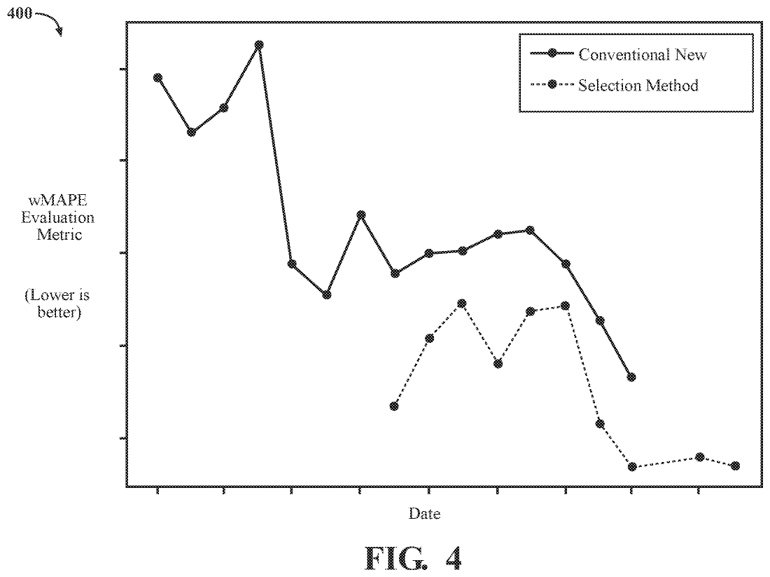

FIG. 4 illustrates comparative performance 400 of ensemble models selected using conventional methods versus ensemble models selected using the methods described herein.

In particular, FIG. 4 depicts these results with reference to a wMAPE evaluation metric in which lower values mean better performance.

Each data point plotted in the example graph represents a case where an ensemble model was determined and task performance of the ensemble model was evaluated. The x-axis of the example graph represents a date when the corresponding ensemble model was determined and evaluated, while the y-axis represents wMAPE metrics calculated for the ensemble models. As depicted, the line representative of the ensemble models selected using the methods described herein have consistently lower wMAPE metrics, which means consistently better performance compared to conventional methods.

Such results provide real-world proof of the technical effects and advantages provided by the ensemble model selection methods described herein.

Example Processing System for Selecting an Ensemble model

FIG. 5 depicts an example processing system 500 configured to perform various aspects described herein, including, for example, method 200 as described above with respect to FIGS. 2A, 2B, and 2C.

Processing system 500 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 500 includes one or more processors 502, one or more input/output devices 504, one or more display devices 506, and one or more network interfaces 508 through which processing system 500 is connected to one or more networks (e.g., a local network, an intranet, the Internet, or any other group of processing systems communicatively connected to each other), and computer-readable medium 512.

In the depicted example, the aforementioned components are coupled by a bus 510, which may generally be configured for data and/or power exchange amongst the components. Bus 510 may be representative of multiple buses, while only one is depicted for simplicity.

Processor(s) 502 are generally configured to retrieve and execute instructions stored in one or more memories, including local memories like the computer-readable medium 512, as well as remote memories and data stores. Similarly, processor(s) 502 are configured to retrieve and store application data residing in local memories like the computer-readable medium 512, as well as remote memories and data stores. More generally, bus 510 is configured to transmit programming instructions and application data among the processor(s) 502, display device(s) 506, network interface(s) 508, and computer-readable medium 512. In certain embodiments, processor(s) 502 are included to be representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware components for communicating information between processing system 500 and a user of processing system 500. For example, input/output device(s) 504 may include input hardware, such as a keyboard, touch screen, button, microphone, and/or other device for receiving inputs from the user. Input/output device(s) 504 may further include display hardware, such as, for example, a monitor, a video card, and/or other another device for sending and/or presenting visual data to the user. In certain embodiments, input/output device(s) Z04 is or includes a graphical user interface.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices.

Network interface(s) 508 provide processing system 500 with access to external networks and thereby to external processing systems. Network interface(s) 508 can generally be any device capable of transmitting and/or receiving data via a wired or wireless network connection. Accordingly, network interface(s) 508 can include a communication transceiver for sending and/or receiving any wired and/or wireless communication. For example, Network interface(s) 508 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 508 includes hardware configured to operate in accordance with the Bluetooth® wireless communication protocol.

Computer-readable medium 512 may be a volatile memory, such as a random access memory (RAM), or a nonvolatile memory, such as nonvolatile random access memory, phase change random access memory, or the like. In this example, computer-readable medium 512 includes a model training component 514, a model subset selection component 516, a model grouping component 518, a cross validation component 520, a model subset evaluation component 522, training datasets 524, validation datasets 526, trained models 528, model groups 530, performance metrics 532, evaluation metrics 534, model subsets 536, an ensemble model 538, training logic 540, determining logic 542, grouping logic 544, selecting logic 546, and penalizing logic 548.

Model training component 514 is configured to train machine learning models how to make predictions and/or perform a desired task. Model training component 514 may feed train datasets to machine learning algorithms to train such models.

Model subset selection component 516 is configured to form different model subsets from a pool/set of trained models. In certain embodiments, model subset selection component 516 is configured to form the different model subsets based on one or more rules.

Model grouping component 518 is configured to group a pool/set of trained models into a plurality of model groups based on at least one characteristic common to each model group.

Cross validation component 520 is configured to use validation datasets to test the performance of various models, for example, in a subset of models.

Model subset evaluation component 522 is configured to evaluate a performance of various model subsets. In certain embodiments, subset evaluation component 522 is configured to determine at least one evaluation metric for each subset of models.

Training datasets 524 include portions datasets partitioned for training machine learning models. Validation datasets 526 include portions datasets partitioned for training machine learning models. Trained models 528 include models trained on training datasets 524. Model groups 530 are groups of trained models 528 with at least one characteristic common. Performance metrics 532 are measures used to assess the performance of a trained model 528. Evaluation metrics 534 are measures used to assess the performance of a model subset 536. Model subsets 536 include two or more models selected from a pool/set of trained models 528. A target ensemble model 538 is a model subset 536 that having a best evaluation metric 534 of a plurality of evaluation metrics 534 associated with a plurality of other model subsets 536.

In certain embodiments, training logic 540 includes logic for training each of a plurality of models on a plurality of training data sets to generate a set of trained models. In certain embodiments, determining logic 542 includes logic for determining a plurality of subsets of trained models from the set of trained models. In certain embodiments, determining logic 542 includes logic for determining a plurality of ensemble outputs for the respective subset of trained models based on a plurality of validation data sets. In certain embodiments, determining logic 542 includes logic for determining at least one evaluation metric for the respective subset of trained models based on the plurality of ensemble outputs. In certain embodiments, determining logic 542 includes logic for determining a best subset of trained models from the plurality of subsets of trained models based on a best evaluation metric of a plurality of evaluation metrics associated with the plurality of subsets of trained models. In certain embodiments, determining logic 542 includes logic for determining a plurality of performance metrics for the respective subset of trained models based on the plurality of ensemble outputs, wherein the at least one evaluation metric comprises: an average of the plurality of performance metrics; or the average of the plurality of performance metrics and a standard deviation of the plurality of performance metrics.

In certain embodiments, grouping logic 544 includes logic for grouping the plurality of models into a plurality of model groups based on at least one characteristic common to each model group.

In certain embodiments, selecting logic 546 includes logic for selecting no more than one model from each model group of the plurality of model groups to form each subset of trained models.

In certain embodiments, penalizing logic 548 includes logic for penalizing models in each of the plurality of model groups based on one or more factors such that each of the plurality of model groups comprises one or more penalized models and one or more non-penalized models, wherein the model selected from each model group to form each subset of trained models comprises a non-penalized model.

Note that FIG. 5 is just one example of a processing system consistent with aspects described herein, and other processing systems having additional, alternative, or fewer components are possible consistent with this disclosure.

### Example Clauses

Implementation details of various aspects of the present disclosure are described in the following numbered clauses.

Clause 1: A method for selecting an ensemble model, comprising: training each of a plurality of models on a plurality of training datasets to generate a set of trained models; determining a plurality of subsets of trained models from the set of trained models; for each respective subset of trained models of the plurality of subsets of trained models: determining a plurality of ensemble outputs for the respective subset of trained models based on a plurality of validation datasets; and determining at least one evaluation metric for the respective subset of trained models based on the plurality of ensemble outputs; and determining an ensemble model as a subset of trained models from the plurality of subsets of trained models having a best evaluation metric among a plurality of evaluation metrics associated with the plurality of subsets of trained models, wherein each subset of trained models comprises a different selection of models from the set of trained models than each other subset of trained models in the plurality of subsets of trained models.

Clause 2: The method of Clause 1, wherein determining the plurality of subsets of trained models from the set of trained models comprises: grouping the plurality of models into a plurality of model groups based on at least one characteristic common to each model group; and selecting no more than one model from each model group of the plurality of model groups to form each subset of trained models.

Clause 3: The method of Clause 2, wherein the at least one characteristic common to each model group comprises model output.

Clause 4: The method of any one of Clauses 2-3, wherein the at least one characteristic common to each model group comprises model type.

Clause 5: The method of any one of Clauses 2-4, wherein determining the plurality of subsets of trained models from the set of trained models further comprises: penalizing models in each of the plurality of model groups based on one or more factors such that each of the plurality of model groups comprises one or more penalized models and one or more non-penalized models, wherein the model selected from each model group to form each subset of trained models comprises a non-penalized model.

Clause 6: The method of Clause 5, wherein the one or more factors comprise at least one of: an amount of model training time, an amount of model parameters, or model parameter types.

Clause 7: The method of any one of Clauses 1-6, wherein an amount of trained models in each subset of the plurality of subsets of trained models is limited based on a maximum number of trained models.

Clause 8: The method of any one of Clauses 1-7, wherein an amount of trained models in each subset of the plurality of subsets of trained models is at least a minimum number of trained models.

Clause 9: The method of any one of Clauses 1-8, wherein each ensemble output of the plurality of ensemble outputs is a median of each output from each model in the respective subset of trained models.

Clause 10: The method of any one of Clauses 1-9, wherein each ensemble output of the plurality of ensemble outputs is a forecast value.

Clause 11: The method of any one of Clauses 1-10, wherein for each respective subset of trained models of the plurality of subsets of trained models, determining the at least one evaluation metric for the respective subset of trained models based on the plurality of ensemble outputs comprises: determining a plurality of performance metrics for the respective subset of trained models based on the plurality of ensemble outputs, wherein the at least one evaluation metric comprises: an average of the plurality of performance metrics; or the average of the plurality of performance metrics and a standard deviation of the plurality of performance metrics.

Clause 12: The method of Clause 11, wherein the plurality of performance metrics comprise weighted mean absolute percentage errors.

Clause 13: A method for selecting an ensemble model, comprising: determining a plurality of subsets of trained models from a set of trained models, wherein the set of trained models comprises a plurality of models trained on a plurality of training datasets; for each respective subset of trained models of the plurality of subsets of trained models: determining a plurality of ensemble outputs for the respective subset of trained models based on a plurality of validation datasets; and determining at least one evaluation metric for the respective subset of trained models based on the plurality of ensemble outputs; and determining an ensemble model as a subset of trained models from the plurality of subsets of trained models having a best evaluation metric among a plurality of evaluation metrics associated with the plurality of subsets of trained models, wherein each subset of trained models comprises a different selection of models from the set of trained models than each other subset of trained models in the plurality of subsets of trained models

Clause 14: A processing system, comprising: a memory comprising computer-executable instructions; and a processor configured to execute the computer-executable instructions and cause the processing system to perform a method in accordance with any one of Clauses 1-13.

Clause 15: A processing system, comprising means for performing a method in accordance with any one of Clauses 1-13.

Clause 16: A non-transitory computer-readable medium comprising computer-executable instructions that, when executed by a processor of a processing system, cause the processing system to perform a method in accordance with any one of Clauses 1-13.

Clause 17: A computer program product embodied on a computer-readable storage medium comprising code for performing a method in accordance with any one of Clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for selecting an ensemble model, comprising:
training each of a plurality of models on a plurality of training datasets to generate a set of trained models;
determining a plurality of subsets of trained models from the set of trained models;
for each respective subset of trained models of the plurality of subsets of trained models:
processing, by each of the trained models in the respective subset of trained models, a plurality of validation datasets to generate a plurality of outputs;
determining a single ensemble output for each validation dataset of the plurality of validation dataset, wherein the single ensemble output associated with each validation dataset is determined based on each output generated by each trained model of the respective subset of trained models when processing the respective validation dataset; and
determining at least one evaluation metric for the respective subset of trained models based on the plurality of ensemble outputs; and
determining an ensemble model as a subset of trained models from the plurality of subsets of trained models having a best evaluation metric among the plurality of evaluation metrics associated with the plurality of subsets of trained models,
wherein each subset of trained models comprises a different selection of models from the set of trained models than each other subset of trained models in the plurality of subsets of trained models.

2. The method of claim 1, wherein determining the plurality of subsets of trained models from the set of trained models comprises:
grouping the plurality of models into a plurality of model groups based on at least one characteristic common to each model group; and
selecting no more than one model from each model group of the plurality of model groups to form each subset of trained models.

2. The method of claim 2, wherein the at least one characteristic common to each model group comprises model output.

4. The method of claim 2, wherein the at least one characteristic common to each model group comprises model type.

5. The method of claim 2, wherein determining the plurality of subsets of trained models from the set of trained models further comprises:
penalizing models in each of the plurality of model groups based on one or more factors such that each of the plurality of model groups comprises one or more penalized models and one or more non-penalized models, wherein the model selected from each model group to form each subset of trained models comprises a non-penalized model.

6. The method of claim 5, wherein the one or more factors comprise at least one of:
an amount of model training time,
an amount of model parameters, or
model parameter types.

7. The method of claim 1, wherein an amount of trained models in each subset of the plurality of subsets of trained models is limited based on a maximum number of trained models.

8. The method of claim 1, wherein an amount of trained models in each subset of the plurality of subsets of trained models is at least a minimum number of trained models.

9. The method of claim 1, wherein the single ensemble output determined for each validation dataset of the plurality of validation datasets comprises a median of each output generated by each trained model in the respective subset of trained models when processing the respective validation dataset.

10. The method of claim 1, wherein each ensemble output of the plurality of ensemble outputs is a forecast value.

11. The method of claim 1, wherein for each respective subset of trained models of the plurality of subsets of trained models, determining the at least one evaluation metric for the respective subset of trained models based on the plurality of ensemble outputs comprises:
determining a plurality of performance metrics for the respective subset of trained models using the plurality of ensemble outputs,
wherein the at least one evaluation metric comprises:
an average of the plurality of performance metrics; or
the average of the plurality of performance metrics and a standard deviation of the plurality of performance metrics.

12. The method of claim 11, wherein the plurality of performance metrics comprise weighted mean absolute percentage errors.

13. An apparatus, comprising:
a memory comprising computer-executable instructions; and
a processor configured to execute the computer-executable instructions and cause the apparatus to:
train each of a plurality of models on a plurality of training data sets to generate a set of trained models;
determine a plurality of subsets of trained models from the set of trained models; for each respective subset of trained models of the plurality of subsets of trained models:
process, by each of the trained models in the respective subset of trained models, a plurality of validation datasets to generate a plurality of outputs;
determine a single ensemble output for each validation dataset of the plurality of validation datasets, wherein the single ensemble output associated with each validation dataset is determine based on each output
generated by each trained model of the respective subset of trained models when processing the respective validation dataset; and
determine at least one evaluation metric for the respective subset of trained models based on the plurality of ensemble outputs; and
determine an ensemble model as a subset of trained models from the plurality of subsets of trained models having a best evaluation metric among the plurality of evaluation metrics associated with the plurality of subsets of trained models,
wherein each subset of trained models comprises a different selection of models from the set of trained models than each other subset of trained models in the plurality of subsets of trained models.

14. The apparatus of claim 13, wherein to determine the plurality of subsets of trained models from the set of trained models, the processor is configured to execute the computer-executable instructions and cause the apparatus to:
group the plurality of models into a plurality of model groups based on at least one characteristic common to each model group; and
select no more than one model from each model group of the plurality of model groups to form each subset of trained models.

15. The apparatus of claim 14, wherein the at least one characteristic common to each model group comprises model output.

16. The apparatus of claim 14, wherein the at least one characteristic common to each model group comprises model type.

17. The apparatus of claim 14, wherein to determine the plurality of subsets of trained model from the set of trained models, the processor is configured to execute the computer-executable instructions and cause the apparatus to:
penalize models in each of the plurality of model groups based on one or more factors such that each of the plurality of model groups comprises one or more penalized models and one or more non-penalized models, wherein the model selected from each model group to form each subset of trained models comprises a non-penalized model.

18. The apparatus of claim 17, wherein the one or more factors comprise at least one of: an amount of model training time, an amount of model parameters, or model parameter types.

19. The apparatus of claim 13, wherein an amount of trained models in each subset of the plurality of subsets of trained models is limited based on a maximum number of trained models.

20. A method for selecting an ensemble model, comprising:
determining a plurality of subsets of trained models from a set of trained models, wherein the set of trained models comprises a plurality of models trained on a plurality of training datasets;
for each respective subset of trained models of the plurality of subsets of trained models:
processing, by each of the trained models in the respective subset of trained models, a plurality of validation datasets to generate a plurality of outputs;
determining a single ensemble output for each validation dataset of the plurality of validation datasets, wherein the single ensemble output associated with each validation dataset is determined based on each of output generated by each trained model of the respective subset of trained models when processing the respective validation dataset; and
determining at least one evaluation metric for the respective subset of trained models based on the plurality of ensemble outputs; and
determining an ensemble model as a subset of trained models from the plurality of subsets of trained models having a best evaluation metric among the plurality of evaluation metrics associated with the plurality of subsets of trained models,
wherein each subset of trained models comprises a different selection of models from the set of trained models than each other subset of trained models in the plurality of subsets of trained models.
